(19) United States
(12) Patent Application Publication
(10) Pub. No.: US 2003/0110487 A1
(43) Pub. Date: Jun. 12, 2003

(54) Computerised method for operating an interactive digital television broadcast

(76) Inventor: Jerome Chouraqui, Paris (FR)

Correspondence Address: ROSENTHAL & OSHA L.L.P., 1221 MCKINNEY AVENUE, SUITE 2800, HOUSTON, TX, 77010, US

(21) Appl. No.: 10/169,640

(22) PCT Filed: Jan. 3, 2001
(86) PCT No.: PCT/FR01/00021

(30) Foreign Application Priority Data
Jan. 3, 2000 (FR) 00/00020

(51) Int. Cl. H04N 7/16

(52) U.S. Cl. 725/25

(57) ABSTRACT

The invention concerns a computerised method for operating an interactive digital television programme broadcast in the form of a digital signal comprising a dataflow corresponding to compressed video images and a dataflow corresponding to at least a multimedia application, as well as service signals for managing said dataflows. The invention is characterised in that it comprises a step which consists in detecting the service signal corresponding to a synchronising cueing signal sequence including: a sequence assigned to designate a multimedia application present in the digital signal, and a signal sequence assigned to the recording of parameters executing said designated multimedia application, and a step which consists in loading said multimedia application and initialising said multimedia application with said executing parameters.

The present invention concerns the interactive digital television domain.

It particularly concerns the field of broadcasting digital television broadcasts, by satellite or cable for example, coupled with multimedia applications, for example publicity banners, computer games, survey questionnaires, etc.

The state of the art includes patent EP0989743 concerning a method of application data transmission in a digital transport flow, characterised in that it provides an application data table containing information concerning the applications executed in each service within the transport flow. The application data table can be made up by a packet ID (PID) fixed value and a table ID (TID) extension value varying depending on the chosen bundle of services. The use of a simple application data table for providing information through all services in the bundle offers several advantages, notably when deciding whether or not to maintain certain applications while switching between the services.

U.S. Pat. No. 5,768,539 and U.S. Pat. No. 5,666,293 are also known. These concern the dynamic programming of a digital leisure terminal. The terminal can be reprogrammed on request for each service offered by one or more service providers. The terminal comprises a network interface module coupling the terminal with a specific type of communication network with a view to receiving a broadband digital channel and exchanging management signals between the terminal and the network. The terminal also comprises a management processor equipped with a program memory. The management processor receives the user input and manages the using of the terminal and the exchange of management signals via the management signals exchange channel. The program memory stores the data received via the broadband digital channel in the form of software that can be executed by the management processor. The digital information received in compressed form via the broadband digital channel is converted by the audio/video processor into signals intended to control an audio/video display device such as a standard television receiver. The management processor executes the received software and stores in memory in order to manage the continuation of the terminal's preferred embodiment, including certain audio/video processor functions and at least some responses to user input.

The present invention concerns, in accordance with its most general accepted form, a computerised method for using an interactive digital broadcast that has been broadcast in the form of a digital signal comprising a data flow corresponding to compressed video images and a data flow corresponding to at least one multimedia application, together with service signals for management of said data flows, said management being characterised in that it comprises a service signal detection stage corresponding to a “synchronisation pulse” sequence comprising:

a sequence allocated to designating a multimedia application present in the digital signal,

together with a signals sequence allocated to recording parameters for the execution of said designated multimedia application,

and a stage for the application loading of said multimedia application and initialization of said multimedia application with said execution parameters.

Advantageously, the method in accordance with the present invention comprises a prior stage of detecting the application ID for activating loading of the application corresponding to said ID.

In a variation of the present invention, it comprises an application unloading stage that can be activated by an instruction triggered by a user.

Preferably, the method in accordance with the present invention comprises an application unloading stage that can be activated by a service signal broadcast in the digital signal.

In accordance with a particular preferred embodiment, said service signal activating the unloading of an application is comprised of a “synchronisation pulse” signal, one of whose sequences is specific, for example a “Pause” sequence.

The present invention also concerns a computer program for using an interactive digital television broadcast that is broadcast in the form of a digital signal comprising a data flow corresponding to compressed video images and a data flow corresponding to at least one multimedia application, together with service signals for management of said data flows, said management being characterised in that it comprises an algorithmic means for detecting the service signal corresponding to a “synchronisation pulse” sequence, an algorithmic means for extracting the data from said sequence corresponding to the application and an algorithmic means for loading said multimedia application in the memory of a computer terminal together with an algorithmic means for initialising said multimedia application with said execution parameters.

The present invention will be better understood on reading the following description, referring to a purely indicative example of its implementation and to the appended figures, where:

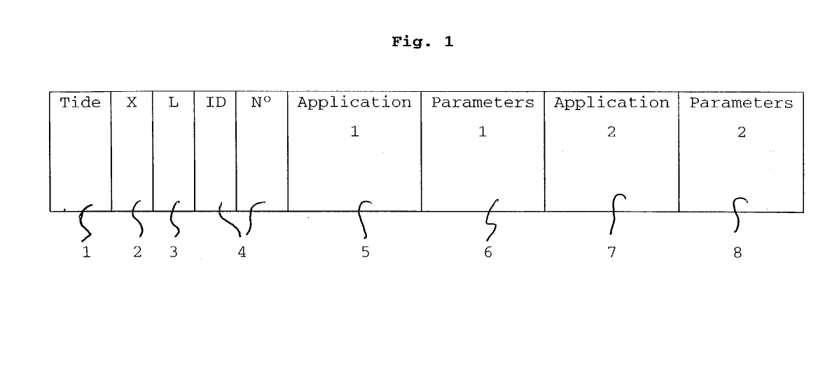

FIG. 1 shows a schematic view of the “synchronisation pulse” service signal,

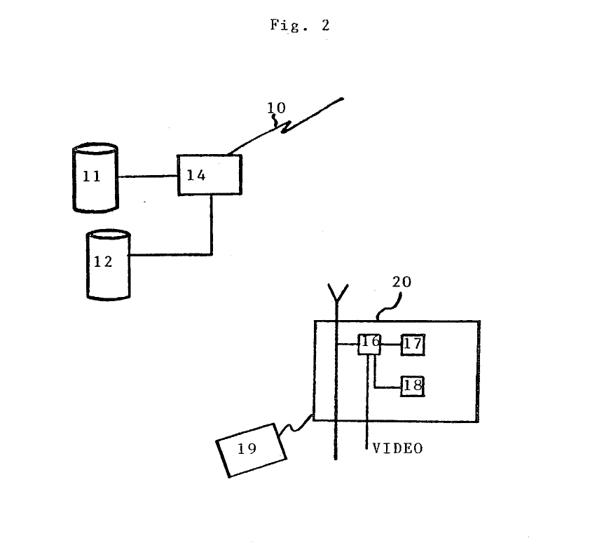

FIG. 2 shows a schematic view of an equipment for using the invention.

The present invention concerns a method for loading a multimedia application in the random access memory of a decoder terminal on receiving a signal called the “synchronisation pulse” in the present patent.

The multimedia application may be composed of, for example:

a graphical, text or video publicity banner;

a configured advertisement;

a game or questionnaire;

a video or graphical animation.

The application is recorded before the digital broadcast is broadcast in a service signal showing a general structure shown as an example in FIG. 1.

In the described example, the sequence comprises three zones (1 to 3) corresponding to the MPEG standard, comprising the initial zone (1) for table identification, zones (2 and 3) for defining the table and notably the table length, a zone (4) for designating the channel, a first zone (5) for identifying a first application file and a supplementary zone (6) comprising the application parameters, together with additional zones (7 and 8) for identifying additional applications and parameters.

The application files themselves are transmitted over the satellite flow, along with the synchronisation pulse but separately from it.

The program for using this sequence is loaded in the decoder's memory at decoder start-up.

When a channel is selected and at each channel change when flicking through channels, the sequence use program identifies the “synchronisation pulse” sequence and begins loading the application recorded in the sequence into random access memory. After the application has been fully loaded, the program in accordance with the present invention runs the application, possibly after initialisation with the parameters recorded in the “synchronisation pulse” sequence.

Once the application has been loaded, it can replace the use program in random access memory, in order to optimise memory resources. The application can comprise a module for detecting a special “synchronisation pulse” sequence. Detection of this sequence triggers the unloading of the application and reloading of the use program.

When the application is run by the use program it initialises itself and starts the user interaction program.

When the application stops, the use program is reactivated to resume capturing “synchronisation pulses”.

The applications may be in highly varied forms. They may cause an interactive publicity banner to be displayed, proposing that users select a different channel by pressing a remote control button, or cause a configurable advertisement to be displayed, proposing that information on the user be sent by pressing a command button.

The same “synchronisation pulse” sequence can correspond to several different services. The digital value in the channel identification ID zone (4) can be used for filtering in order to select features.

FIG. 2 shows a schematic view of an architecture for using the invention.

The broadcast is provided by an editor in digital signal form (10) by a link with the broadcaster's server (11). This server also receives the files (12) corresponding to the applications. The editor also transmits the data corresponding to the synchronisation of the different elements, notably information on the events triggering transmission of a “synchronisation pulse” service signal. All of the data flows are multiplexed by a multiplexer (14) and then broadcast.

The user has a decoder (20) comprising a computer (16) possessing a memory (17) in which the use program is recorded. Random access memory (18), and possibly the main memory (17), can be used to temporarily record the application loaded from the “synchronisation pulse” sequence. Remote control means (19) can be used to interact with the application.

1- A computerised method for using an interactive digital broadcast that has been broadcast in the form of a digital signal comprising a data flow corresponding to compressed video images and a data flow corresponding to at least one multimedia application, together with service signals for management of said data flows, said management being characterised in that it comprises a service signal detection stage corresponding to a “synchronisation pulse” sequence comprising:
a sequence allocated to designating a multimedia application present in the digital signal,
together with a signals sequence allocated to recording parameters for the execution of said designated multimedia application,
and a stage for the application loading of said multimedia application and initialization of said multimedia application with said execution parameters.

2- A computerised method for using an interactive digital television broadcast in accordance with claim 1, characterised in that it comprises a prior stage of detecting the application ID for activating the loading of the application corresponding to said ID.

3- A computerised method for using an interactive digital television broadcast in accordance with claim 1 or 2, characterised in that it comprises an application unloading stage that can be activated by an instruction triggered by a user.

4- A computerised method for using an interactive digital television broadcast in accordance with at least one of the preceding claims, characterised in that it comprises an application unloading stage that can be activated by a service signal broadcast in the digital signal.

5- A computerised method for using an interactive digital television broadcast in accordance with claim 4, characterised in that said service signal activating the unloading of an application is comprised of a “synchronisation pulse” signal, one of whose sequences is a specific sequence.

6- A method for using an interactive digital television broadcast that is broadcast in the form of a digital signal comprising a data flow corresponding to compressed video images and a data flow corresponding to at least one multimedia application, together with service signals for management of said data flows, said management being characterised in that it comprises an algorithmic means of detecting the service signal corresponding to a “synchronisation pulse” sequence, an algorithmic means of extracting the data from said sequence corresponding to the application and an algorithmic means of loading said multimedia application in the memory of a computer terminal together with an algorithmic means of initialising said multimedia application with said execution parameters.
